(19) United States
(12) Patent Application Publication
(10) Pub. No.: US 2022/0141913 A1
(43) Pub. Date: May 5, 2022

(54) CORE NETWORK FOR MOBILE COMMUNICATION SYSTEM

(71) Applicant: INSTITUTE FOR INFORMATION INDUSTRY, Taipei (TW)

(72) Inventor: Ming-Chun LIU, Taipei (TW)

(21) Appl. No.: 17/103,906

(22) Filed: Nov. 24, 2020

(30) Foreign Application Priority Data
Nov. 5, 2020 (TW) 109138707

(51) Int. Cl. H04W 76/25; H04W 72/04; H04W 8/08; H04W 48/16; H04W 60/04

(52) U.S. Cl. CPC H04W 76/25; H04W 72/0493; H04W 60/04; H04W 48/16; H04W 8/08

(57) ABSTRACT

A core network for mobile communication system is provided. The core network includes a first network function (NF) element, a second NF element, and an operations, administration and maintenance (OAM) element. The OAM element periodically transmits a resource quota status message to the second NF element to obtain a count number of the resource of first NF element and a limit value of the count number via the second NF element, and adjusts the limit value of the resource of the first NF element according to the count number and the limit value of the resource of the first NF element.

### CROSS-REFERENCE TO RELATED APPLICATION

This application claims priority to Taiwan Application Serial Number 109138707, filed Nov. 5, 2020, which is herein incorporated by reference in its entirety.

### BACKGROUND

### Field of Invention

The present disclosure relates to a core network for mobile communication system. More particularly, the present disclosure relates to dynamically adjust available resource quota by an operations administration and maintenance (OAM) element of the core network according to a resource usage status periodically obtained from a network function (NF) element.

### Description of Related Art

In the 5G mobile communication system, after the registration and communication process of the network slice is completed, the connection between the user equipment and the network slice or the establishment of a protocol data unit session will affect the available resource quota. If the resource quota of the network slice is insufficient, the user equipment will be rejected by a network function for connection or a certain network service.

Accordingly, an urgent need exists in the art to provide a resource allocation mechanism which can monitor and adjust the resource quota of each of the network slice in time.

### SUMMARY

An objective of the present disclosure is to provide a resource allocation mechanism which can periodically monitor and adjust the status of resource quota of the network slice through the overall planning and control functions of an operations, administration and maintenance (OAM) element, or add a warning mechanism to achieve more efficient resource allocation.

To achieve the aforesaid objective, the present disclosure provides a core network for mobile communication system which comprises a first network function (NF) element, a second NF element, and an operations administration and maintenance (OAM) element. The first NF element is configured to provide a resource. The second NF element is configured to manage the first NF element. The OAM element is configured to execute operations comprising: transmitting a quota status inquiry message to the second NF element periodically to make the second NF element receive a count value corresponding to the resource from the first NF element; receiving a resource usage message from the second NF element, the resource usage message carrying the count value and an upper limit value of the count value; and adjusting the upper limit value of the count value according to the count value corresponding to the resource and the upper limit value of the count value.

Moreover, the present disclosure further provides a core network for mobile communication system which comprises a first network slice and an operations administration and maintenance (OAM) element. The first network slice comprises a first network function (NF) element and a second NF element. The first NF element is configured to provide a first resource. The second NF element is configured to manage the first NF element. The OAM element is configured to execute operations comprising: receiving a quota warning message which carries a first count value corresponding to the first resource and a first upper limit value of the first count value; and adjusting the first upper limit value of the first count value according to the first count value and the first upper limit value of the first count value carried by the quota warning message. When the first count value corresponding to the first resource is greater than or equal to a first threshold, the first NF element transmits the first count value to the second NF element.

Furthermore, the present disclosure further provides a core network for mobile communication system which comprises a first network slice and an operations administration and maintenance (OAM) element. The first network slice comprises a first network function (NF) element and a second NF element. The first NF element is configured to provide a first resource and a backup resource. The second NF element is configured to manage the first NF element. The OAM element is configured to execute operations comprising: receiving a quota warning message, which carries a first count value corresponding to the first resource and a first upper limit value of the first count value, from the second NF element; and adjusting the first upper limit value of the first count value corresponding to the first resource according to the first count value and the first upper limit value carried by the quota warning message. When the backup resource decreases, the first NF element transmits the first count value to the second NF element.

The detailed technology and preferred embodiments implemented for the present invention are described in the following paragraphs accompanying the appended drawings for people skilled in this field to well appreciate the features of the claimed invention.

### BRIEF DESCRIPTION OF THE DRAWINGS

The invention can be more fully understood by reading the following detailed description of the embodiment, with reference made to the accompanying drawings as follows:

FIG. 1 is a schematic view of the OAM element actively obtains the count value and adjusts the upper limit value according to the present disclosure;

FIG. 2 is a schematic view of the OAM element actively obtains the count value and adjusts the upper limit value according to the present disclosure;

FIG. 3 depicts an implementation scenario after the first NF element connects with the user equipment;

FIG. 4 depicts an implementation scenario after the first NF element establishes the protocol unit data session with the user equipment;

FIG. 5 is a schematic view of the OAM element actively obtains the count value, the first NF element actively reports the count value, and the OAM element adjusts the upper limit value according to the present disclosure;

FIG. 6 is a schematic view of the first NF element actively reports the count value, and the OAM element adjusts the upper limit value according to the present disclosure;

FIG. 7 depicts an implementation scenario of the OAM element allocates the resource of other network slice to the first NF element;

FIG. 8 depicts an implementation scenario of the OAM element allocates the resource of other network slice to the first NF element;

FIG. 9 depicts an implementation scenario of the OAM element allocates the resource of other network slice to the first NF element;

FIG. 10 is a schematic view of the first NF element actively reports the count value, and the OAM element adjusts the upper limit value according to the present disclosure;

FIG. 11 is a schematic view of the first NF element actively reports the count value, and the OAM element adjusts the upper limit value according to the present disclosure;

FIG. 12 is a schematic view of the first NF element actively reports the count value, and the OAM element adjusts the upper limit value according to the present disclosure; and

FIG. 13 is a schematic view of the first NF element actively reports the count value, and the OAM element adjusts the upper limit value according to the present disclosure.

### DETAILED DESCRIPTION

Reference will now be made in detail to the present embodiments of the invention, examples of which are illustrated in the accompanying drawings, and are not intended to limit the present invention to any specific environment, applications or particular implementations described in these embodiments. Therefore, description of these embodiments is only for purpose of illustration rather than to limit the present invention. Wherever possible, the same reference numbers are used in the drawings and the description to refer to the same or like parts. It shall be appreciated that, in the following embodiments and the attached drawings, elements unrelated to the present invention are omitted from depiction; and dimensional relationships among individual elements in the attached drawings are provided only for ease of understanding, but not to limit the actual scale.

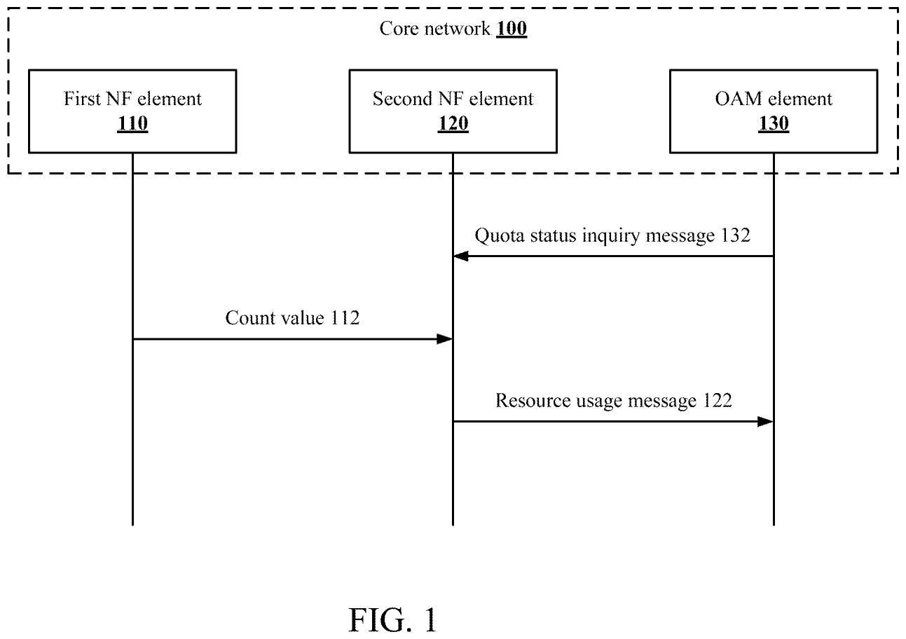

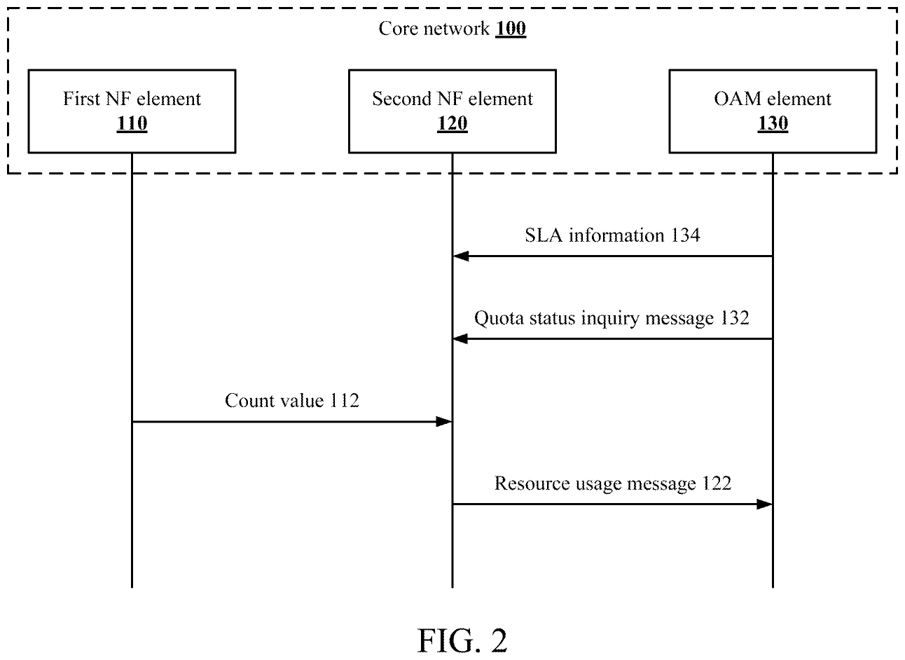

A first embodiment of the present invention is as shown in FIG. 1 to FIG. 5. FIG. 1 and FIG. 2 are schematic views of an operations administration and maintenance (OAM) element actively obtains the count value and adjusts the upper limit value corresponding to the available resource of a network function (NF) element according to the present disclosure. As shown in FIG. 1, core network 100 for mobile communication system includes a first NF element 110, a second NF element 120, and the OAM element 130. The mobile communication system may be the 5G mobile communication system or any mobile communication systems based on the orthogonal frequency division multiple (OFDM) access technology. The first NF element 110 may be a session management function (SMF) element, and the second NF element 120 may be a policy control function (PCF) element or a network slice selection function (NSSF) element, but not limited thereto.

The first NF element 110 provides a resource. The second NF element 120 manages the first NF element 110 so that the first NF element 110 can communicate with the OAM element 130 via the second NF element 120. In detail, reference is made to FIG. 2, the first NF element 110 and the second NF element 120 form a network slice, the OAM element 130 transmits a service level agreement (SLA) information 134 to the second NF element 120. The SLA information 134 carries resources for multiple network slices, and the resources are allocated to each of the network slices by the second NF element 120.

When the second NF element 120 only exists in the network slice including the first NF element 110, the second NF element 120 allocates all resources to the first NF element 110 after receiving the SLA information 134. When the second NF component 120 exists in multiple network slices, the second NF component 120 needs to allocate all resources to the first NF component in each of the network slice after receiving the SLA information 134. In addition, the second NF element 120 can determine the upper limit value corresponding to the available resources of the first NF element 110 and the upper limit value corresponding to the available resources of each of the first NF element in other network slices when allocating the resources.

In order to prevent a user equipment (UE) from waiting too long for connection or being rejected too many times, the OAM element 130 transmits a quota status inquiry message 132 to the second NF element 120 periodically after the second NF element 120 finishes allocating the resources to make the second NF element 120 receive a current count value 112 corresponding to the resource from the first NF element 110. Then, the second NF component 120 transmits a resource usage message 122 related to the resource of the first NF element 110 to the OAM element 130. Since the upper limit value of the available resources for the first NF element 110 is determined by the second NF element 120, the resource usage message 122 sent by the second NF element 120 includes not only the count value corresponding to the available resources for the first NF element 110, but also the upper limit value of the count value. After receiving the resource usage message 122 from the second NF element 120, the OAM element 130 adjusts the upper limit value of the count value according to the count value corresponding to the resource and the upper limit value of the count value.

In addition, the OAM element 130 allocates the resources for limiting the connected UE number and the resources for limiting established PDU session number to the second NF element 120 through transmitting the SLA information 134. The second NF element 120 determines the upper limit value corresponding to the available resources for limiting the connected UE number and the upper limit value corresponding to the available resources for limiting established PDU session number for the first NF element of each of the network slices.

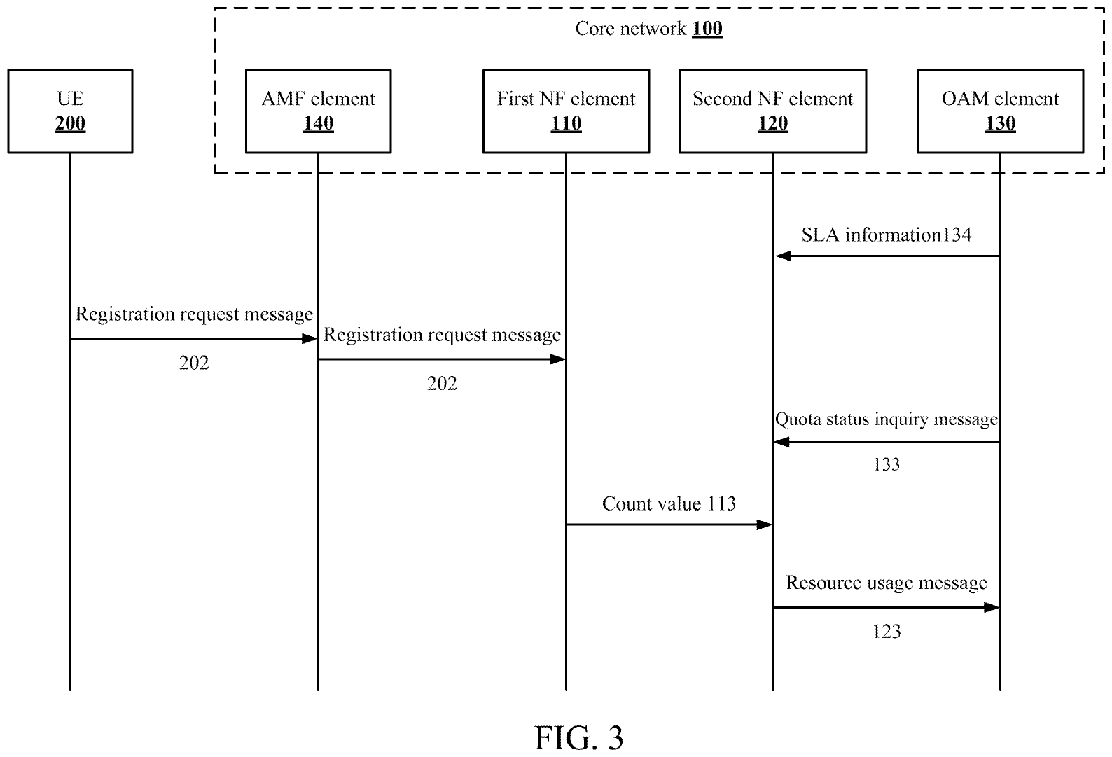

Specifically, the core network 100 includes an access and mobility management function (AMF) element 140. When the resources allocated by the OAM element 130 limits the connected UE number, the count value of the resource, provided by the first NF element 110, corresponds to the connected UE number. For example, reference is made to FIG. 3, the AMF element 140 receives a registration request message 202 from a UE 200, and transmit the registration request message 202 to the first NF element 110. When the first NF element 110 accepts the UE 200 according to the registration request message 202, the first NF element 110 increases the count value to record the connected UE number. In other words, every time a UE is connected to the first NF element 110, the first NF element 110 increases the count value.

During the period that the first NF element 110 is establishing a connection with the UE 200, the OAM element 130 still periodically transmits the quota status inquiry message 133 to the second NF element 120 to make the second NF element 120 obtain the current count value 113 from the first NF element 110 and transmit the resource usage message 123 carrying the count value 113 and the upper limit value to the OAM element 130.

When the OAM element 130 determines that the connected UE number is greater than or equal to a threshold, the OAM element 130 increases the upper limit value of the resource according to the connected UE number and the upper limit value. In other words, if the OAM element 130 determines that the connected UE number is greater than or equal to a threshold, the OAM element 130 needs to allocate the available resources for limiting the connected UE number from other network slice to the first NF element 110.

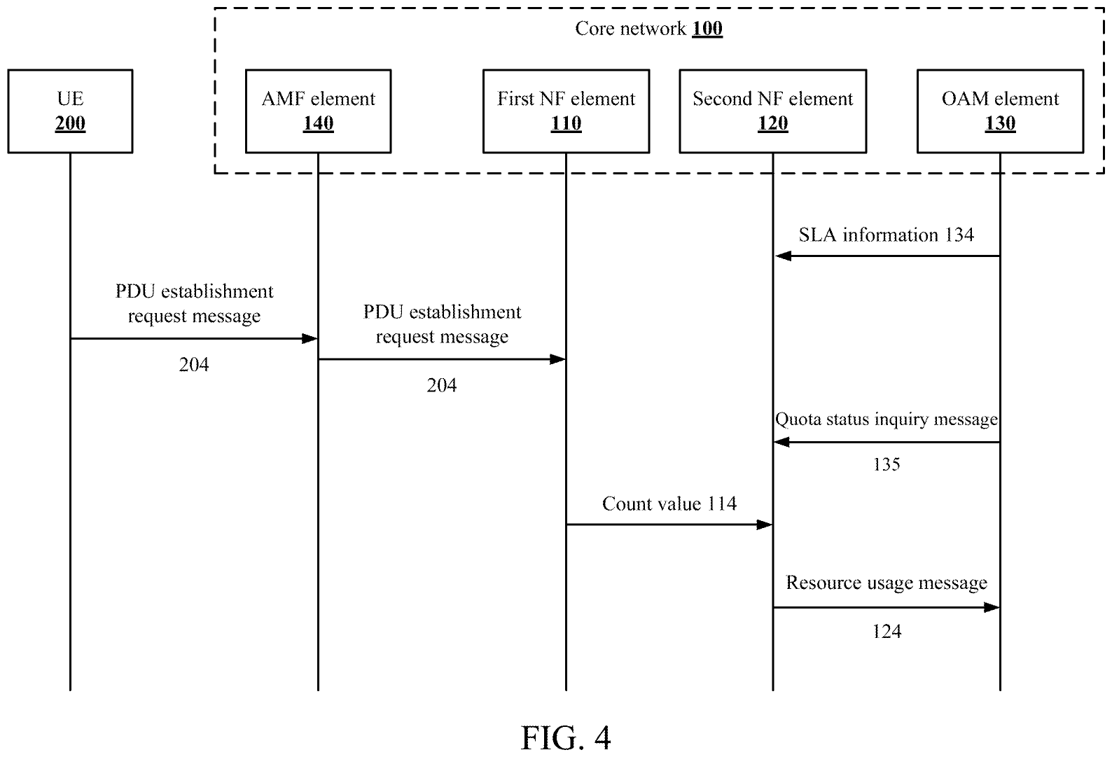

In other embodiments, when the resources allocated by the OAM element 130 limits the established PDU session number, the count value of the resource, provided by the first NF element 110, corresponds to the established PDU session number. For example, reference is made to FIG. 4, after connected with the UE 200, the AMF element 140 receives a PDU establishment request message 204 from a UE 200, and transmit the PDU establishment request message 204 to the first NF element 110. When the first NF element 110 establishes a PDU session according to the PDU establishment request message 204, the first NF element 110 increases the count value to record the PDU session number. In other words, every time a PDU session is established, the first NF element 110 increases the count value.

Similarly, during the period that the first NF element 110 is establishing a PDU session for the UE 200, the OAM element 130 still periodically transmits the quota status inquiry message 134 to the second NF element 120 to make the second NF element 120 obtain the current count value 114 from the first NF element 110 and transmit the resource usage message 124 carrying the count value 114 and the upper limit value to the OAM element 130.

When the OAM element 130 determines that the established PDU session number is greater than or equal to a threshold, the OAM element 130 increases the upper limit value of the resource according to the established PDU session number and the upper limit value. In other words, if the OAM element 130 determines that the established PDU session number is greater than or equal to a threshold, the OAM element 130 needs to allocate the available resources for limiting the established PDU session number from other network slice to the first NF element 110.

In other embodiments, in addition to periodically monitoring the resource usage quota of the first NF element 110 (i.e., the aforementioned count value) by the OAM element 130, the first NF element 110 can also actively report the current count value 115 to the OAM element 130 via the second NF element 120.

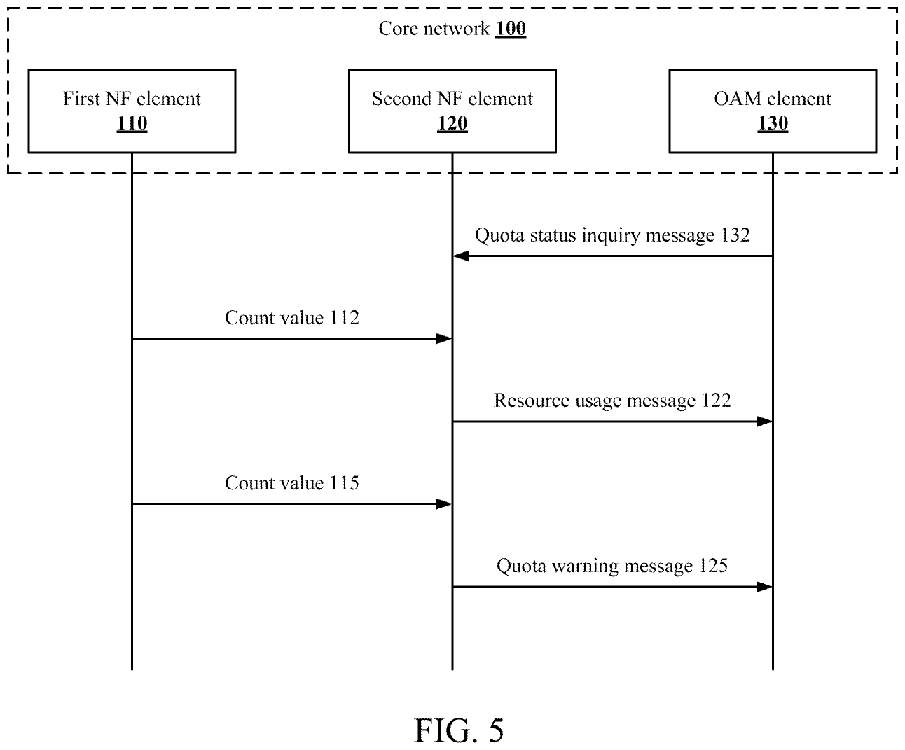

Reference is made to FIG. 5, when the count value of the resource is greater than or equal to a threshold, the first NF element 110 transmits a quota warning message 125 to the second NF element 120, and the quota warning message 125 to will be transmitted to the OAM element 130 via the second NF element 120. The quota warning message 125 carries the count value 115 and the upper limit value so that the OAM element 130 increases the upper limit value corresponding to the resource provided by the first NF element 110 according to the quota warning message 125 after transmitting the quota status inquiry message 132 and before transmitting the next quota status inquiry message.

It shall be noted that, the core network 100 of 5G mobile communication system is designed as service-based architecture (SBA) which includes different types of functions. The core network 100 may be considered as a collection of these functions, and these functions may be implemented in hardware or software by one or more devices (e.g., the servers) and connected to each other via specific interfaces. In other words, each of the functions (e.g., aforementioned AMF, SMF, PCF, NSSF, OAM, etc.) in the core network 100 is executed by an entity or a virtual machine (VM).

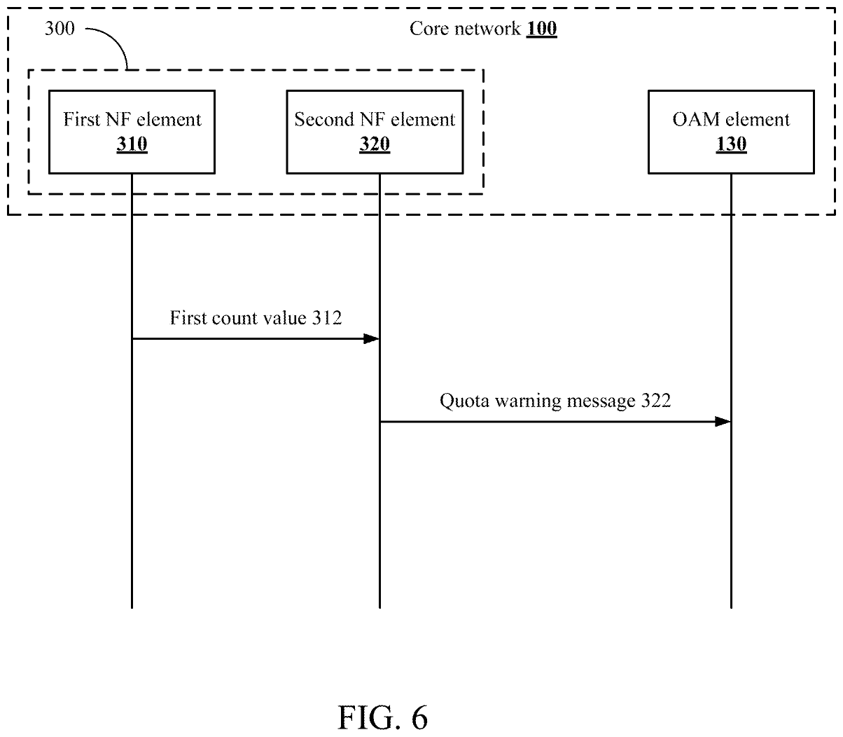

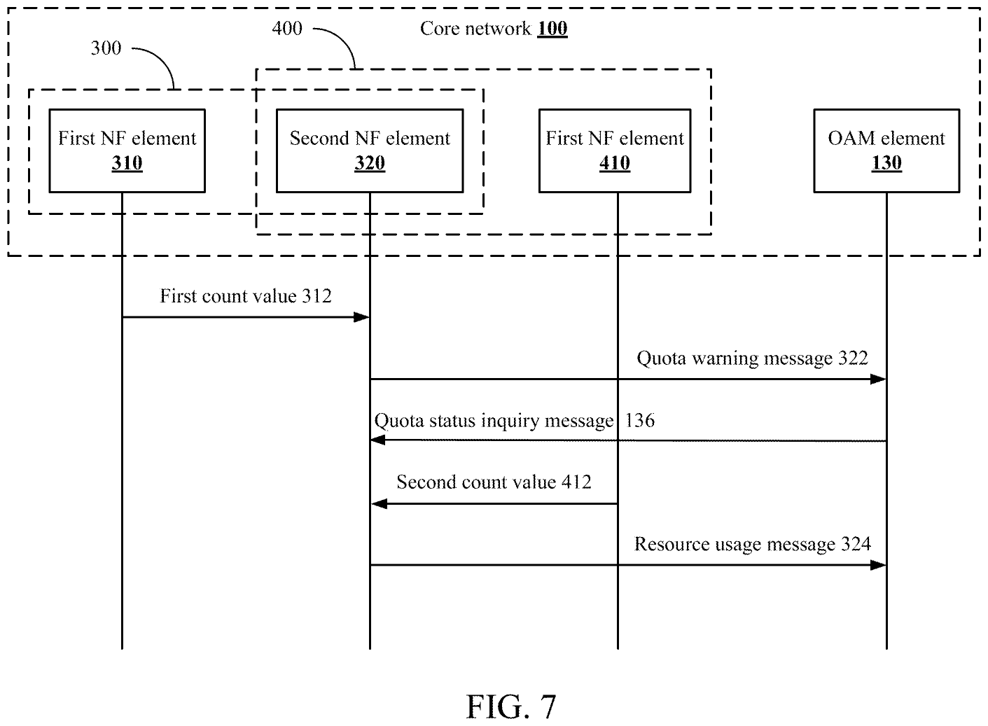

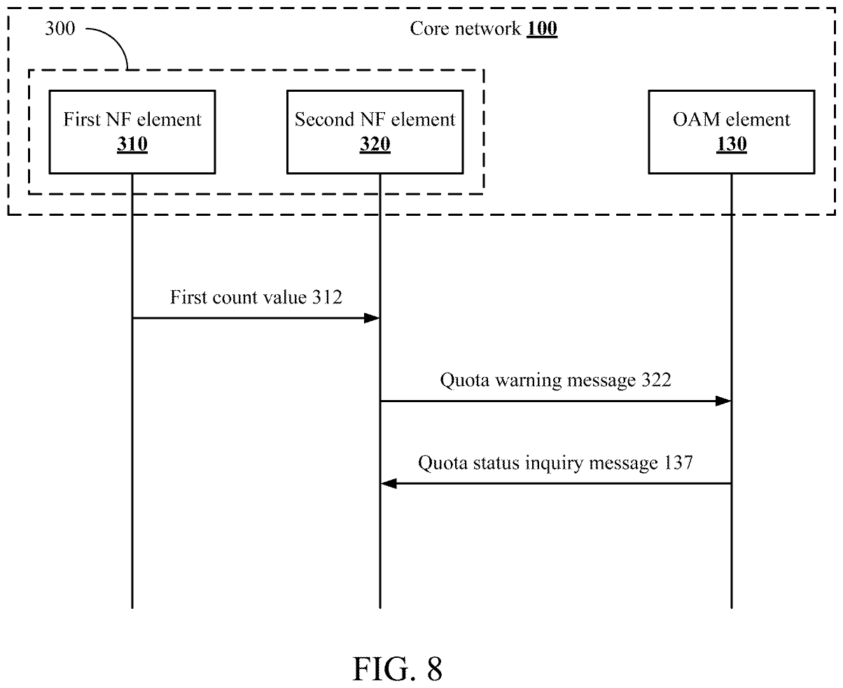

A second embodiment of the present invention is as shown in FIG. 6 to FIG. 8. FIG. 6 is a schematic view of the first NF element actively reports the count value, and the OAM element adjusts the upper limit value. FIG. 7 and FIG. 8 depict different implementation scenarios of the OAM element allocates the resource of other network slice to the first NF element. Different from the first embodiment in that the OAM element periodically obtains the resource usage of the first NF element from the second NF element, in this embodiment, the first NF element will actively report the resource usage of the first NF element to the OAM element when the resources are about to be insufficient, so that the OAM element can instantly adjust the resource quota of the first NF element.

The core network 100 includes a first network slice 300 and the OAM element 130. The first network slice 300 includes a first NF element 310 and a second NF element 320. The first NF element 310 provides a first resource. The second NF element 320 manages the first NF element 310 so that the first NF element 110 can communicate with the OAM element 130 via the second NF element 120.

As described in the first embodiment, after the OAM element 130 allocates the resources to the second NF element 320, the second NF element 320 can decide the quota of the first resource. When the first count value corresponding to the first resource is greater than or equal to a first threshold, it means that the first resource is nearly running out or already running out (i.e., the first count value is equal to the first upper limit value), the first NF element 310 actively transmits the current first count value 312 to the second NF element 320. Then, the second NF element 320 transmits the quota warning message 322 which carries a first count value corresponding to the first resource and the first upper limit value of the first count value to the OAM element 130 so that the OAM element 130 can adjust the first upper limit value of the first count value according to the first count value and the first upper limit value.

When the first upper limit of the first resource is adjusted, the OAM element 130 usually reallocates the resources from other network slices to the first network slice 300. For example, reference is made to FIG. 7, the core network 100 further includes a second network slice 400. The second network slice 400 includes a first NF element 410 and the second NF element 320. In other words, the second NF element 320 is shared with the first network slice 300 and the second network slice 400. The second NF element 320 allocates the resources, allocated by the OAM element 130, to the first NF element 310 of the first network slice 300 and the first NF element 410 of the second network slice 400.

The first NF element 410 of the second network slice 400 provides a second resource. After receiving the quota warning message 322, if the OAM element 130 decides to reallocate the second resource of the second network slice 400 to the first NF element 310 of the first network slice 300, the OAM element 130 transmits a quota status inquiry message 136 to the second NF element 320 to make the second NF element 320 receive a second count value 412 corresponding to the second resource from the first NF element 410 of the second network slice 400.

The second NF element 320 transmits a resource usage message 324 to the OAM element 130 after obtaining the second count value 412 corresponding to the second resource. The resource usage message 324 carries the second count value 412 and a second upper limit value of the second count value. Both of the first count value and the second count value correspond to the connected UE number or the established PDU session number.

After receiving the resource usage message 324 from the second NF element 320, the OAM element 130 determines whether the second count value corresponding to the second resource is greater than or equal to a second threshold to determine if the second resource still has enough quota for reallocating to the first NF element 310 of the first network slice 300.

When the second count value is less than the second threshold which means the second resource still has enough quota for reallocating to the first NF element 310 of the first network slice 300. Therefore, the OAM element 130 increases the first upper limit value corresponding to the first resource according to the second count value and the second upper limit value of the second count value. When the second count value is equal to or greater than the second threshold which means the second resource does not have enough quota for reallocating to the first NF element 310 of the first network slice 300. Therefore, the OAM element 130 does not adjust the first upper limit value corresponding to the first resource temporarily.

In other embodiments, in addition that the first NF element 310 actively reports the count value to the OAM element 130 via the second NF element 320, the OAM element 130 may also transmit the quota status inquiry message 136 to the second NF element 320 periodically to make the second NF element 320 receive the first count value corresponding to the first resource from the first NF element 310 so as to monitor the resource quota of the first resource of the first NF element 310, and adjusts the first upper limit value of the first count value according to the first count value, the first upper limit value, the second count value, and the second upper limit value, as shown in FIG. 8.

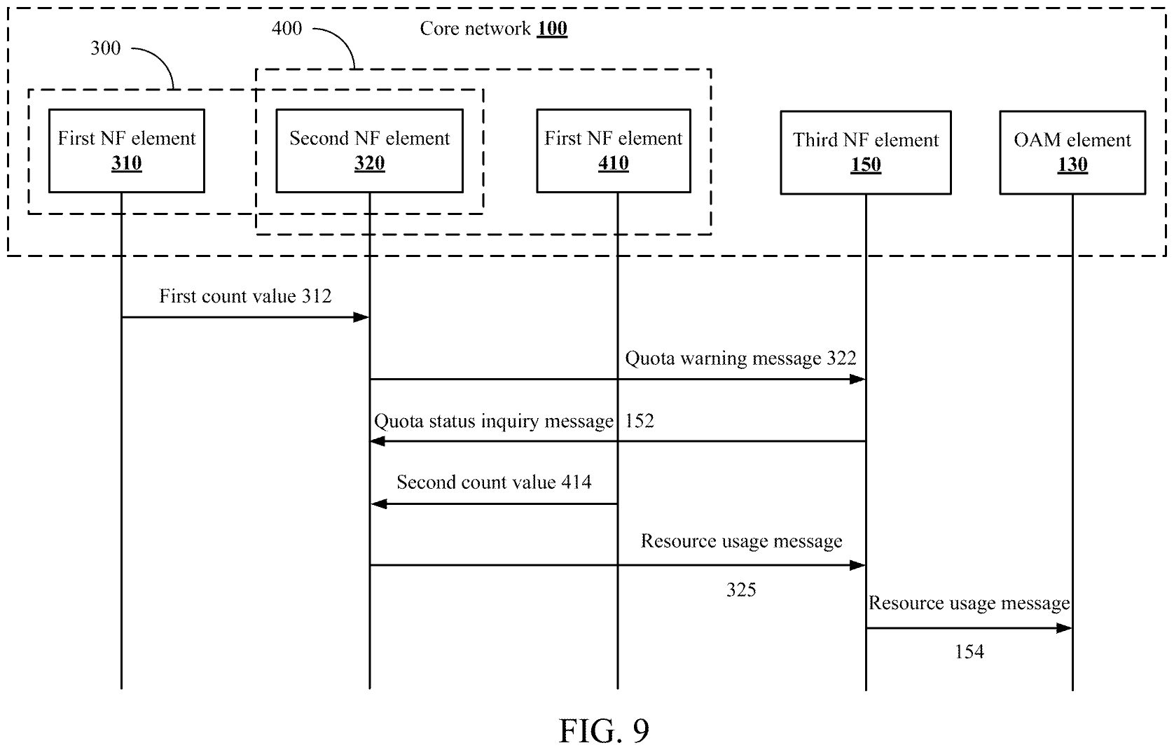

A third embodiment of the present invention is as shown in FIG. 9. The third embodiment is an extension of the second embodiment. In this embodiment, the core network 100 includes a third NF element 150 and the second network slice 400. The third NF element 150 may be the PCF element or the NSSF element, but not limited thereto. The third NF element 150 is an element shared with multiple network slices. If the third NF element 150 is existed in the core network 100, the OAM element 130 collects the resource status of the second network slice 400 and the resource status of other second network slices via the third NF element 150. In other words, when the third NF element 150 is existed in the core network 100, the resource status of each of the network slices are collected by the third NF element 150 and reported to the OAM element 130 via the third NF element 150.

Different from the second embodiment, in this embodiment, the second NF element 320 transmits the quota warning message 322 to the third NF element 150. In detail, the third NF element 150 transmits the quota status inquiry message 152 to the second NF element 320 in response to the quota warning message 322 to make the first NF element 410 of the second network slice 400 transmit the current second count value 414 corresponding to the second resource to the second NF element 320.

Next, the second NF element 320 transmits the resource usage message 324 carrying the second count value 414 and the second upper limit value to the third NF element 150. After receiving the resource usage message 324 of the second network slice 400 and the resource usage message of other second network slices, the third NF element 150 transmits the resource usage message 154 carrying the second count value and the second upper limit value of each of the second network slices to the OAM element 130.

The OAM element 130 determines whether the second count value 414 is greater than or equal to the second threshold according to the resource usage message 154, transmitted by the third NF element 150, to determine of the second resource still has enough quota for reallocating to the first NF element 310 of the first network slice 300.

When the second count value is less than the second threshold which means the second resource still has enough quota for reallocating to the first NF element 310 of the first network slice 300. Therefore, the OAM element 130 increases the first upper limit value corresponding to the first resource according to the second count value and the second upper limit value of the second count value. When the second count value is equal to or greater than the second threshold which means the second resource does not have enough quota for reallocating to the first NF element 310 of the first network slice 300. Therefore, the OAM element 130 does not adjust the first upper limit value corresponding to the first resource temporarily.

It shall be appreciated that, to simplify the description, only the second network slice 400 is depicted in FIG. 9. However, the number of the second network slice is not intended to limit the scope of the present invention. In other embodiments, the core network 100 may include multiple second network slices which share the second NF element 320 with the first network slice. Under the circumstance, the resource usage message 154 includes the second count value corresponding to the second resource of the first NF element of the second network slices and the second upper limit value of the second count value.

After the OAM element 130 receives the resource usage message 324 transmitted by the second NF element 320 via the third NF element, the OAM element 130 needs to determine whether all the second count values reach the second threshold, and increase the first upper limit value of the first resource based on the second count value which is less than the second threshold and the corresponding second upper limit value so as to reallocate the available second resource to the first NF element 310 of the first network slice.

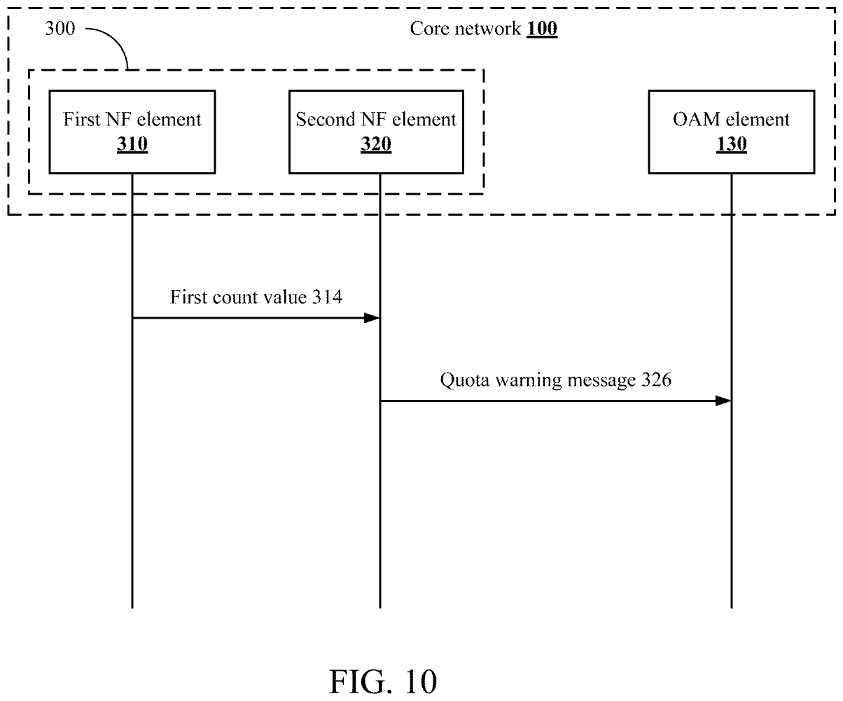

A fourth embodiment of the present invention is as shown in FIG. 10 to FIG. 12. FIG. 10 to FIG. 12 are schematic views of the first NF element actively reports the count value, and the OAM element adjusts the upper limit value. In this embodiment, the OAM element 130 divides the resources allocated to the second NF element 320 into general resources and backup resources. Specifically, the first network slice 300 includes the first NF element 310 and the second NF element 320. The first NF element 310 provides a first resource and a backup resource. The backup resource can be used as a trigger condition for the first NF element 310 to actively report the usage status of the resource to the OAM element 130. In other words, when the first NF element 310 allocates the backup resources for establishing a connection or a PDU session, the first NF element 310 must actively report the current first count value 314 to the OAM element 130.

The first NF element 310 first allocates the first resources for establishing the connection or the PDU session with the UE, if the first resources are insufficient or are all allocated, the first NF element 310 will allocate the backup resources. When the backup resource decreases, the first NF element 310 transmits the first count value 314 to the second NF element 320, and the second NF element 320 transmits the quota warning message 326 carrying the first count value 314 and the first upper limit value corresponding to the first resources to the OAM element 130.

After receiving the quota warning message 326 from the second NF element 320, the OAM element 130 adjusts the first upper limit value of the first count value corresponding to the first resource according to the first count value and the first upper limit value carried by the quota warning message 326.

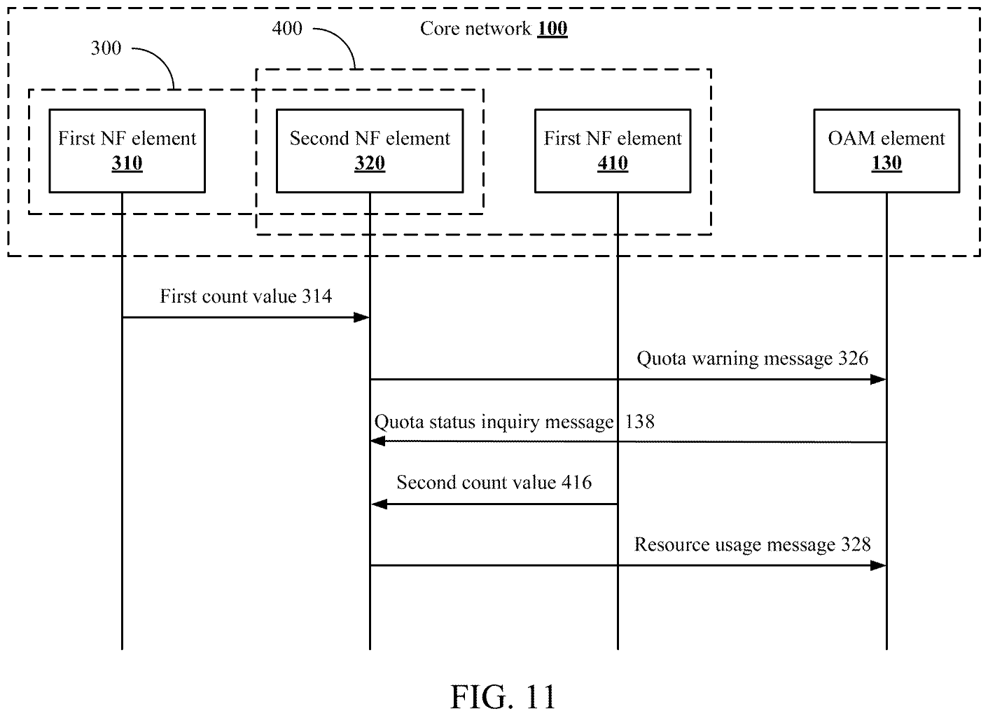

In other embodiments, reference is made to FIG. 11, the core network 100 includes the second network slice 400. The first NF element 410 of the second network slice 400 provides the second resource. After receiving the quota warning message 326 from the second NF element 320, the OAM element 130 further transmits the quota status inquiry message 138 to the second NF element 320 to make the second NF element 320 receive the second count value 416 corresponding to the second resource from the first NF element 410 of the second network slice 400. The second NF element 320 transmits the resource usage message 328 carrying the second count value 416 and the second upper limit value, corresponding to the second resources, of the second count value.

Then, the OAM element 130 determines whether the second count value 416 corresponding to the second resource is greater than or equal to a second threshold. When the second count value is less than the second threshold, the OAM element 130 increases the first upper limit value corresponding to the first resource according to the second count value 416 and the second upper limit value of the second count value. When the second count value is equal to or greater than the second threshold, OAM element 130 does not adjust the first upper limit value corresponding to the first resource temporarily. In one embodiment, both of the first count value and the second count value correspond to the connected UE number or the established PDU session number.

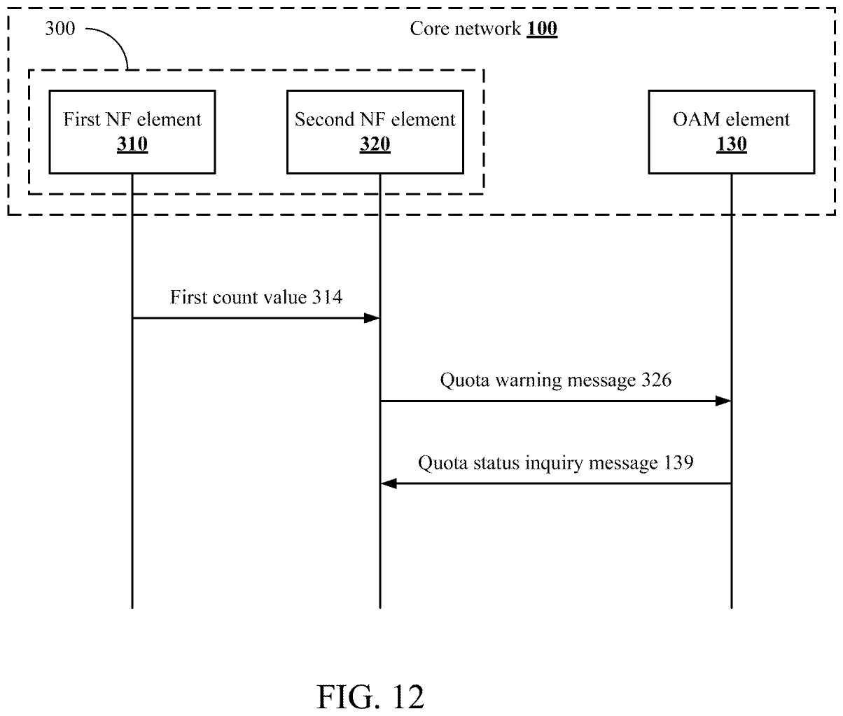

In addition, in other embodiments, transmit the quota status inquiry message 139 to the second NF element 320 periodically to make the second NF element 320 receive the first count value corresponding to the first resource from the first NF element 310 so as to adjust the first upper limit value of the first count value according to the current first count value and the first upper limit value, as shown in FIG. 12.

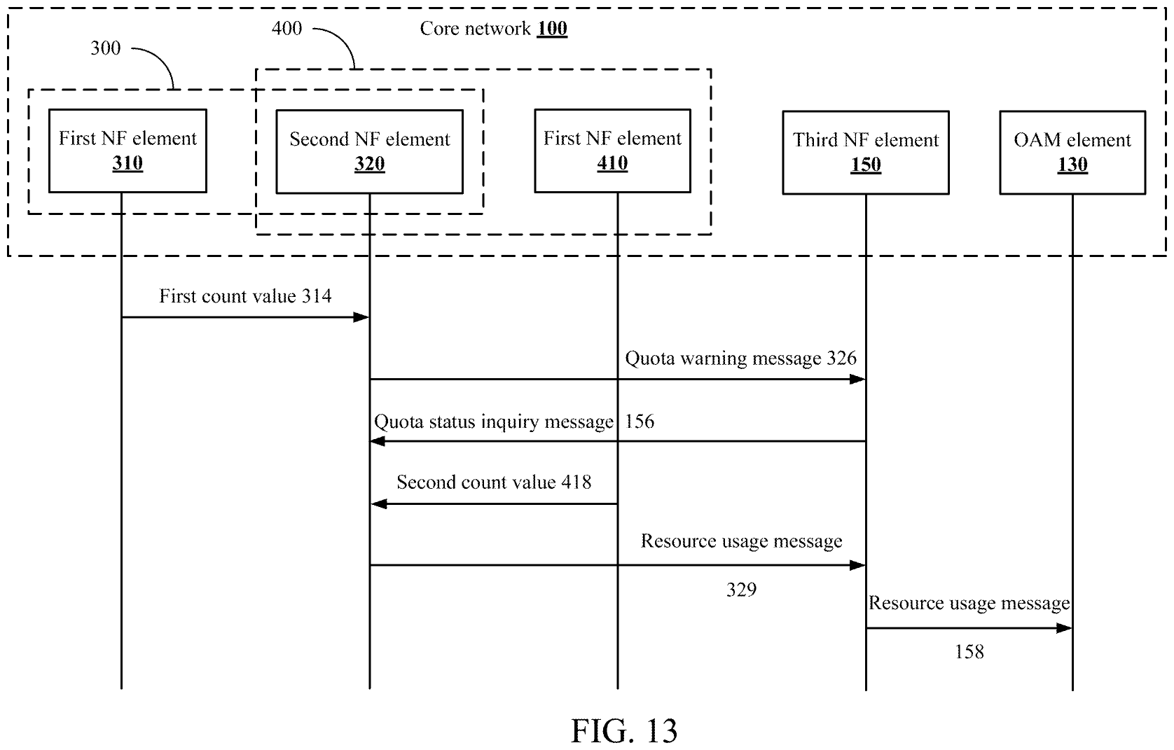

A fifth embodiment of the present invention is as shown in FIG. 13. The fifth embodiment is an extension of the fourth embodiment. In this embodiment, the core network 100 includes the third NF element 150 and the second network slice 400. As described in the third embodiment, the third NF element 150 is an element shared with multiple network slices. If the third NF element 150 is existed in the core network 100, the OAM element 130 collects the resource status of the second network slice 400 and the resource status of other second network slices via the third NF element 150. In other words, when the third NF element 150 is existed in the core network 100, the resource status of each of the network slices are collected by the third NF element 150 and reported to the OAM element 130 via the third NF element 150.

Different from the fourth embodiment, in this embodiment, the second NF element 320 transmits the quota warning message 326 to the third NF element 150, and the third NF element 150 transmits the quota status inquiry message 156 to the second NF element 320 in response to the quota warning message 326 to make the second NF element 320 obtain the current second count value 418 corresponding to the second resource from the first NF element 410 of the second network slice 400.

Next, the second NF element 320 transmits the resource usage message 329 carrying the second count value 418 and the second upper limit value to the third NF element 150. After receiving the resource usage message 329 of the second network slice 400 and the resource usage message of other second network slices, the third NF element 150 transmits the resource usage message 159 carrying the second count value and the second upper limit value of each of the second network slices to the OAM element 130.

The OAM element 130 determines whether the second count value 418 is greater than or equal to the second threshold according to the resource usage message 158, transmitted by the third NF element 150, to determine if the second resource still has enough quota for reallocating to the first NF element 310 of the first network slice 300.

When the second count value 418 is less than the second threshold which means the second resource still has enough quota for reallocating to the first NF element 310 of the first network slice 300. Therefore, the OAM element 130 increases the first upper limit value corresponding to the first resource according to the second count value and the second upper limit value of the second count value. When the second count value 418 is equal to or greater than the second threshold which means the second resource does not have enough quota for reallocating to the first NF element 310 of the first network slice 300. Therefore, the OAM element 130 does not adjust the first upper limit value corresponding to the first resource temporarily.

According to the above descriptions, the resource allocation mechanism of the present disclosure is able to periodically monitor and adjust the status of resource quota of the network slice, or add a warning mechanism to make the first NF element actively report the status of resource quota so as to achieve more efficient resource allocation.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A core network for mobile communication system, comprising:
a first network function (NF) element, being configured to provide a resource;
a second NF element, being configured to manage the first NF element; and
an operations administration and maintenance (OAM) element, being configured to execute operations comprising:
transmitting a quota status inquiry message to the second NF element periodically to make the second NF element receive a count value corresponding to the resource from the first NF element;
receiving a resource usage message from the second NF element, the resource usage message carrying the count value and an upper limit value of the count value; and
adjusting the upper limit value of the count value according to the count value corresponding to the resource and the upper limit value of the count value.

2. The core network of claim 1, wherein the OAM element is further configured to transmits a service level agreement (SLA) information to the second NF element to allocate the resource to the first NF element via the second NF element.

3. The core network of claim 1, wherein the count value of the resource, provided by the first NF element, corresponds to a connected user equipment (UE) number, and when the connected UE number is greater than or equal to a threshold, the OAM element is further configured to increase the upper limit value of the resource according to the connected UE number and the upper limit value.

4. The core network of claim 3, further comprising:
an access and mobility management function (AMF) element, being configured to receive a registration request message from a UE, and transmit the registration request message to the first NF element;
wherein when the first NF element accepts the UE according to the registration request message, the first NF element increases the count value to record the connected UE number.

5. The core network of claim 1, wherein the count value of the resource, provided by the first NF element, corresponds to an established protocol data unit (PDU) session number, and when the established PDU session number is greater than or equal to a threshold, the OAM element increases the upper limit value of the resource according to the PDU session number and the upper limit value.

6. The core network of claim 5, further comprising:
an access and mobility management function (AMF) element, being configured to receive a PDU establishment request message from a UE, and transmit the PDU establishment request message to the first NF element;
wherein when the first NF element establishes a PDU session according to the PDU establishment request message, the first NF element increases the count value to record the established PDU session number.

7. The core network of claim 1, wherein the first NF element is a session management function element, and the second NF element is a policy control function element.

8. The core network of claim 1, wherein when the count value of the resource is greater than or equal to a threshold, the first NF element transmits a quota warning message to the OAM element via the second NF element to make the OAM element increase the upper limit value of the resource according to the quota warning message.

9. A core network for mobile communication system, comprising:
a first network slice which comprises:
a first network function (NF) element, being configured to provide a first resource; and
a second NF element, being configured to manage the first NF element;
an operations administration and maintenance (OAM) element, being configured to execute operations comprising:
receiving a quota warning message which carries a first count value corresponding to the first resource and a first upper limit value of the first count value; and
adjusting the first upper limit value of the first count value according to the first count value and the first upper limit value of the first count value carried by the quota warning message;
wherein when the first count value corresponding to the first resource is greater than or equal to a first threshold, the first NF element transmits the first count value to the second NF element.

10. The core network of claim 9, further comprising a second network slice, a first NF element of the second network slice being configured to provide a second resource, and the OAM element being further configured to execute operations comprising:
transmitting a quota status inquiry message to the second NF element to make the second NF element receive a second count value corresponding to the second resource from the first NF element of the second network slice after receiving the quota warning message;
receiving a resource usage message from the second NF element, the resource usage message carrying the second count value and a second upper limit value of the second count value;
determining whether the second count value corresponding to the second resource is greater than or equal to a second threshold; and
increasing the first upper limit value corresponding to the first resource according to the second count value and the second upper limit value of the second count value when the second count value is less than the second threshold.

11. The core network of claim 10, wherein both of the first count value and the second count value correspond to a connected UE number.

12. The core network of claim 10, wherein both of the first count value and the second count value correspond to an established protocol data unit (PDU) session number.

13. The core network of claim 9, wherein the OAM element is further configured to execute operations comprising:
transmitting a quota status inquiry message to the second NF element periodically to make the second NF element receive the first count value corresponding to the first resource from the first NF element; and
adjusting the first upper limit value of the first count value according to the first count value and the first upper limit value.

14. A core network for mobile communication system, comprising:
a first network slice which comprises:
a first network function (NF) element, being configured to provide a first resource and a backup resource; and
a second NF element, being configured to manage the first NF element;
an operations administration and maintenance (OAM) element, being configured to execute operations comprising:
receiving a quota warning message, which carries a first count value corresponding to the first resource and a first upper limit value of the first count value, from the second NF element; and
adjusting the first upper limit value of the first count value corresponding to the first resource according to the first count value and the first upper limit value carried by the quota warning message;
wherein when the backup resource decreases, the first NF element transmits the first count value to the second NF element.

15. The core network of claim 14, further comprising a second network slice, a first NF element of the second network slice being configured to provide a second resource, and the OAM element being further configured to execute operations comprising:
transmitting a quota status inquiry message to the second NF element to make the second NF element receive a second count value corresponding to the second resource from the first NF element of the second network slice after receiving the quota warning message;
receiving a resource usage message from the second NF element, the resource usage message carrying the second count value and a second upper limit value of the second count value;
determining whether the second count value corresponding to the second resource is greater than or equal to a second threshold; and
increasing the first upper limit value corresponding to the first resource according to the second count value and the second upper limit value of the second count value when the second count value is less than the second threshold.

16. The core network of claim 15, wherein both of the first count value and the second count value correspond to a connected UE number.

17. The core network of claim 15, wherein both of the first count value and the second count value correspond to an established protocol data unit (PDU) session number.

18. The core network of claim 14, wherein the OAM element is further configured to execute operations comprising:
transmitting a quota status inquiry message to the second NF element periodically to make the second NF element receive the first count value corresponding to the first resource from the first NF element; and
adjusting the first upper limit value of the first count value according to the first count value and the first upper limit value.
